(19) United States
(12) Patent Application Publication
(10) Pub. No.: US 2024/0098598 A1
(43) Pub. Date: Mar. 21, 2024

(54) COMMUNICATION SYSTEM AND COMMUNICATION METHOD

(71) Applicant: TOYOTA JIDOSHA KABUSHIKI KAISHA, Toyota-shi Aichi-ken (JP)

(72) Inventors: Lei ZHONG, Chuo-ku Tokyo-to (JP); Jing MA, Yokohama-shi Kanagawa-ken (JP); Xiao SHAO, Kawasaki-shi Kanagawa-ken (JP)

(73) Assignee: TOYOTA JIDOSHA KABUSHIKI KAISHA, Toyota-shi Aichi-ken (JP)

(21) Appl. No.: 18/242,592

(22) Filed: Sep. 6, 2023

(30) Foreign Application Priority Data
Sep. 15, 2022 (JP) 2022-147314

(51) Int. Cl. H04W 36/22

(52) U.S. Cl. CPC H04W 36/22

(57) ABSTRACT

A communication system comprising: a first base station having a first controller and a second base station having a second controller, wherein the first controller transmits a handover request to the second base station when a handover to the second base station is required for a user terminal, the second controller transmits a handover response including congestion state information at the second base station to the first base station in response to receiving the handover request, and the first controller transmits a handover command including the congestion state information or a data transmission control command according to the congestion state information to the user terminal in response to receiving the handover response.

### CROSS REFERENCE TO THE RELATED APPLICATION

This application claims the benefit of Japanese Patent Application No. 2022-147314, filed on Sep. 15, 2022, which is hereby incorporated by reference herein in its entirety.

### BACKGROUND

### Technical Field

The present disclosure relates to a handover process in a communication system.

### Description of the Related Art

The user terminal (UE) in motion has a specification that continues the same data communication as before even after handover (Non-Patent Documents 1 and 2). Therefore, even if the handover target base station is congested, the previous communication is continued, which makes the congestion more severe, adversely affecting important communications and also leading to a decrease in the overall network utilization efficiency.

### CITATION LIST

### Non-Patent Literature

Non-Patent Literature 1: 3GPP TS 38.300 9.2.3
Non-Patent Literature 2: 3GPP TS 23.502 4.9.1.3

### SUMMARY

One aspect of the present disclosure is to provide a communication system capable of performing handover that can flatten traffic and improve network utilization efficiency.

One aspect of the present disclosure is a communication system including a first base station having a first controller and a second base station having a second controller, wherein the first controller transmits a handover request to the second base station when a user terminal needs to handover to the second base station, and the second controller transmits a handover response including state information at the second base station to the first base station in response to receiving the handover request, and the first controller transmits the handover command including the state information or a data transmission control command according to the state information to the user terminal in response to receiving the handover response. It is a communication system characterized in that.

Another aspect of the present disclosure is a communication method including: transmitting a handover request to the second base station when the first base station determines that a handover to a second base station of the user terminal is necessary; transmitting a handover response including state information at the second base station to the first base station in response to receiving the handover request; and transmitting a handover command including a data transmission control command according to the state information to the user terminal in response to receiving the handover response.

According to aspects of the present disclosure, it is possible to flatten traffic and improve network utilization efficiency.

### BRIEF DESCRIPTION OF THE DRAWINGS

FIG. 1 is a diagram showing an example of a system configuration of a communication system according to the first embodiment.

FIG. 2 is a diagram showing an example of a handover process.

FIG. 3 is a diagram showing another example of the handover process.

### DESCRIPTION OF THE EMBODIMENTS

One embodiment of the present disclosure is a communication system including a first base station having a first controller and a second base station having a second controller.

The first controller of the first base station transmits a handover request to the second base station when the user terminal needs to hand over to the second base station. The necessity of handover can be determined based on the reception intensity of the base station around the user terminal transmitted from the user terminal, and when the reception intensity of the signal from the second base station exceeds the threshold value (the threshold value is, for example, the reception intensity of the signal from the first base station), it can be determined that handover to the second base station is necessary. The handover request may be sent to the second base station directly from the first base station to the second base station, or from the first base station to another device (e.g., a core network) or via processing.

The second controller of the second base station transmits a handover response including congestion status information in the second base station to the first base station in response to receiving the handover request. The congestion state information may be binary information indicating whether or not congestion is occurring, or may be information representing the degree of congestion. The presence and degree of congestion can be determined based on, for example, at least one of the utilization rate of the arithmetic processor, the utilization rate of the memory rate, the usage rate of the communication band, and the usage rate of the wireless resource (for example, resource block) in the base station. Further, the state information may be information indicating at how much data rate or data amount the user terminal performs communication after the handover. It is possible to determine at what data rate or data amount communication should be performed based on the presence or absence of occurrence of congestion in the second base station or the degree of the congestion. The handover response may be transmitted directly from the second base station to the first base station, or from the second base station to the first base station via another device (e.g., a core network) or processing.

The first controller of the first base station transmits a handover command to the user terminal in response to receiving a handover response from the second base station. Here, the handover command includes the congestion state information or a data transmission control command according to the congestion state information. The data transmission control command may include, for example, information indicating at what data rate or amount of data the user terminal performs communication after handover to the second base station. It is possible to determine at what data rate or amount of data communication should be performed based on the congestion state information of the second base station. The handover command may be transmitted directly from the first base station to the user terminal, or from the first base station to another device (e.g., a core network) or to the user terminal via processing.

The user terminal switches the connection destination from the first base station to the second base station in response to the handover command from the first base station. After handover from the first base station to the second base station, the user terminal communicates at a data rate or data amount according to the data transmission control command, or at a data rate or data amount according to the congestion state information. The user terminal may further control data transmission for each communication data according to the priority of the communication data.

According to the above embodiment, the user terminal can perform communication at a data rate or data amount according to the situation of congestion in the second base station after the handover to the second base station. Therefore, for example, when a congestion is occurring in the second base station, it is possible to suppress the seriousness of the problem, and it is possible to realize flattening of traffic and improving usage efficiency of the entire base station.

Hereinafter, embodiments of the present disclosure will be described based on the drawings. The following configuration of the embodiment is exemplary, and the present disclosure is not limited to the configuration of the embodiment.

### First Embodiment

(System Configuration)

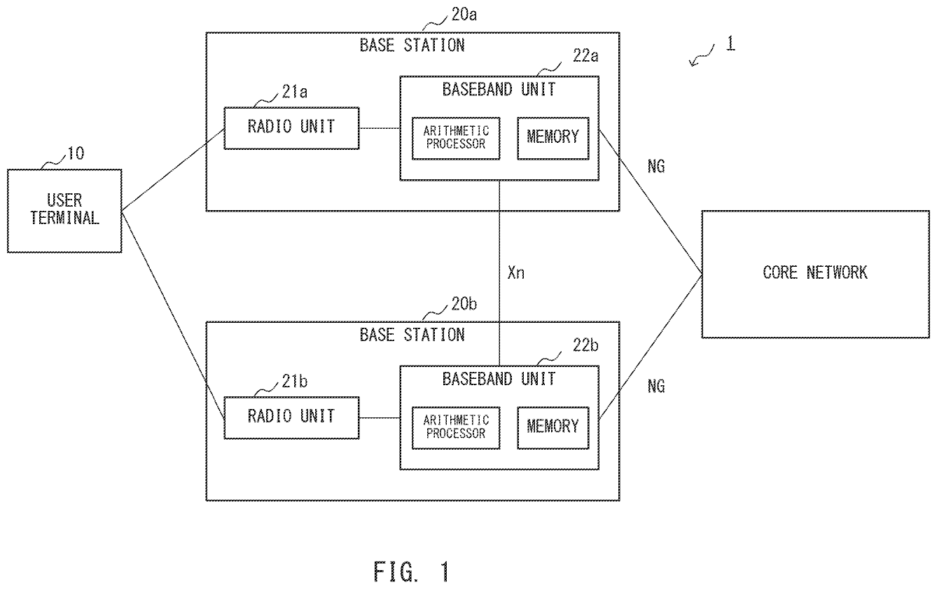

FIG. 1 is a diagram showing an example of a system configuration of the wireless communication system 1 according to the first embodiment. The wireless communication system 1 includes a user terminal 10, a base station 20a, 20b, and a core network 30. In the following, the wireless communication system according to the first embodiment will be described as a 5G stand-alone system. However, the wireless communication system 1 may be any wireless communication system such as a 5G non-stand-alone system (sharing 4G and 5G), 4G, 3G, and wireless LAN.

The base station 20a includes a radio device 21a and a baseband device 22a. The radio device 21a is in charge of wireless transmission/reception and sub-functions of a wireless physical layer, transmits/receives radio waves between the user terminal 10, and converts signals into analog and digital reciprocal. The baseband device 22a is responsible for functions of radio resource allocation (MAC), retransmission control (RLC), packet encryption (PDCP), and radio resource management (RRC) of the terminal. The functions of the baseband device 22a can also be distributed and implemented in a plurality of devices (for example, a Distributed Unit (DU) and a Central Unit (CU)). The radio device 21a and the baseband device 22a (or the DU and the CU) may be physically located at different positions or at the same position. The baseband device 22a (or DU and CU) is configured to include an arithmetic processor such as a CPU, a memory (main storage), an auxiliary storage device, a communication interface, and the like, and its functions are realized by the arithmetic processor executing a computer program. The arithmetic processor is an example of a controller in the present disclosure.

The base station 20b includes a radio device 21b and a baseband device 22b. Since the configuration of the base station 20b is the same as that of the base station 20a, the description thereof will be omitted. In the following description, when the base station is comprehensively described, the subscript (a or b) in the reference numeral may be omitted.

The baseband device 22a of the base station 20a and the baseband device 22b of the base station 20b are connected by an Xn interface. However, depending on the base station 20, the base station 20 may not be directly connected to the baseband device 22 of the other base stations 20.

The core network 30 performs authentication of the user terminal 10, location management of the user terminal 10, policy control, packet forwarding control, establishment of a communication path, and exchange of data with an external network. The core network 30 is connected to the base station 20a and the base station 20b via an NG (N2/N3) interface. The core network 30 is also connected to an external network such as the Internet or a mobile carrier. The core network 30 has, in more detail, functions of a control plane and a user plane. The function of the control plane includes an AMF (Access and Mobility Management Function) for managing connection and movement of the user terminal 10, a SMF (Session Management Function) for managing sessions of the user plane, and a UDM (Unified Data Management) for managing subscriber information. The user plane connects the base station and an external network to exchange user data with the user terminal.

The user terminal 10 is a terminal having a 5G wireless communication function, and is typically a smartphone terminal, a tablet terminal, and a personal computer. The user terminal 10 has a wireless communication unit and an information processing unit, and uses a wireless communication device to connect to the base station 20 for wireless communication.

### Handover Processing Example 1

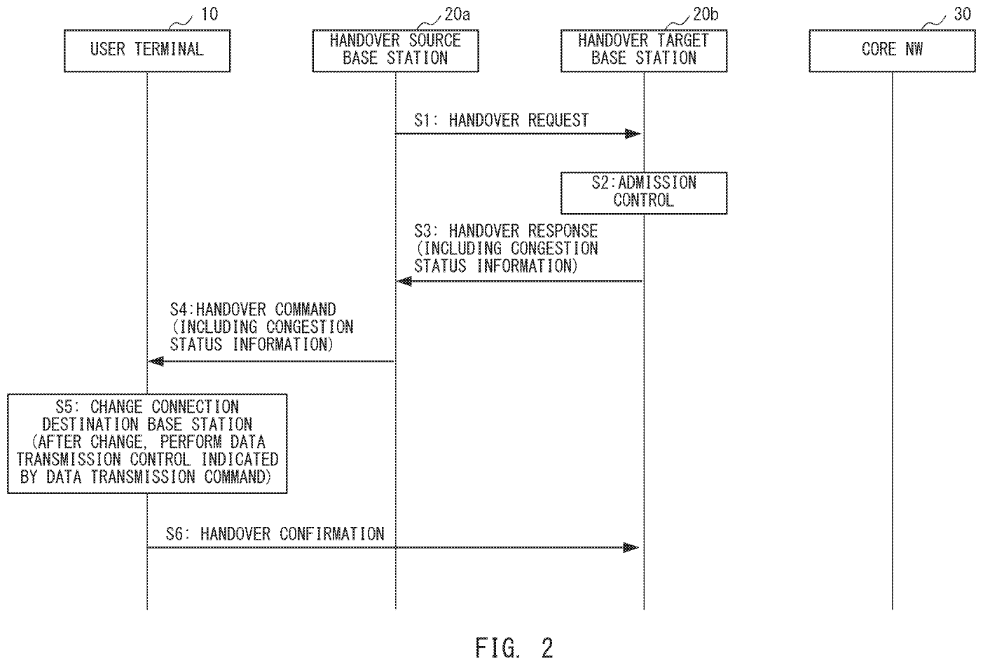

FIG. 2 is a diagram showing an example of a handover process. In this example, it is assumed that the user terminal 10 hands over from the base station 20a to the base station 20b. Hereinafter, the base station 20a is also referred to as a handover source base station (or source base station), and the base station 20b is also referred to as a handover target base station (or target base station).

FIG. 2 shows a handover process when the handover source base station 20a and the handover target base station 20b can communicate directly (or not via the core network 30).

The handover process illustrated in FIG. 2 is started when the handover source base station 20a determines that the user terminal 10 needs to be handover to the handover target base station 20b. The necessity determination of the handover in the handover source base station 20a is performed as follows. The user terminal 10 measures the reception intensity of the signal transmitted from the surrounding base stations, and transmits the measurement result to the base station to which it is currently connected (handover source base station 20a). When the reception strength of the other base station signal exceeds the threshold value, the handover source base station 20a determines that a handover to one of the other base stations is necessary. The threshold value is, for example, the reception strength of the signal of the handover source base station 20a. When the reception strengths of the plurality of base station signals are higher than the threshold value, for example, the base station having the highest reception strength is specified as the base station to be handover.

When the handover process is started, in step S1, the baseband device 22a of the handover source base station 20a transmits a handover request to the baseband device 22b of the handover target base station 20b.

In step S2, the baseband device 22b of the handover target base station 20b performs admission control in response to receiving a handover request from the handover source base station 20a. The admission control is a process of securing wireless resources according to the situation of the network and controlling communication according to the situation. The baseband device 22b of the handover target base station 20b also acquires information indicating the state of (hereinafter referred to as state information). The congestion state information may be binary information indicating whether or not a congestion has occurred, or may be information indicating a degree of the congestion. The occurrence or non-occurrence of a congestion and the degree of the congestion can be determined based on, for example, at least one of the usage rate of the arithmetic processor in the base station, the usage rate of the memory, the usage rate of the communication band, and the usage rate of the wireless resource (for example, the resource block). The communication band and radio resource utilization rates can be obtained, for example, by: The baseband device 22b holds the allocation result of the wireless resource in memory. The baseband device 22b can calculate the usage rate of the communication band and the usage rate of the wireless resource from the allocation information held in the memory. The congestion state information may be the amount of memory, the communication band, and the amount of wireless resource used.

In step S3, the baseband device 22b of the handover target base station 20b transmits a handover request acknowledgement including congestion state information to the baseband device 22a of the handover source base station 20a.

In step S4, the baseband device 22a of the handover source base station 20a transmits a handover command (Handover Command) instructing the user terminal 10 to handover to the handover target base station 20b in response to receiving the handover response. As a result, the handover source base station 20a causes the user terminal 10 to execute the handover. The handover command may be, for example, an RRC Reconfiguration message indicating a wireless connection to the handover destination base station 20b. At the same time, the baseband device 22a transmits a command (hereinafter also referred to as a data transmission control command) related to data transmission after the handover to the user terminal 10 together with the handover command. The data transmission control command includes information indicating at what data rate or amount of data the user terminal 10 performs communication after the handover. The handover source base station 20a may include the state information in the handover response and transmit the state information to the user terminal 10, and the user terminal 10 may determine at what data rate or amount of data should be transmitted after the handover.

In step S5, the user terminal 10 changes the connection destination base station from the base station 20a to the base station 20b in response to receiving a handover command from the handover source base station 20a. After the change of the connection destination, the user terminal 10 executes transmission control so as to perform transmission at the data rate or the amount of data included in the data transmission control command. Alternatively, when the user terminal 10 is receiving the congestion state information, the user terminal 10 executes transmission control so as to perform transmission at a data rate or data amount according to the state indicated by the congestion state information. When the user terminal 10 needs to suppress the data rate or the data amounts after the handover, the throughput of the communication having a low priority may be reduced or stopped. An example of a method of reducing throughput is shaping (buffering packets that exceed the bandwidth limit and sending them later). Further, depending on the content of the communication, policing (discarding packets exceeding the upper limit of the bandwidth) may be adopted. In addition, for any of the communication of image, video, and sound, a part or all of the image quality/sound quality, frame rate, and sampling rate may be reduced. Further, in consideration of the priority of the communication data, the user terminal 10 may reduce the throughput of the communication having a low priority for logging and entertainment purposes without changing, for example, the communication having a high priority related to autonomous driving. Further, conversely, if the occurrence occurs at the handover source base station 20a and is not occurring at the handover target base station 20b, control may be performed such that the communication is performed while increasing the throughput.

In step S6, the user terminal 10 transmits a handover confirmation indicating that the handover is completed to the handover target base station 20b. The handover confirmation may be, for example, an RRCReconfigurationComplete message.

By the above processing, the handover processing from the handover source base station 20a of the user terminal 10 to the handover target base station 20b is completed.

### Handover Processing Example 2

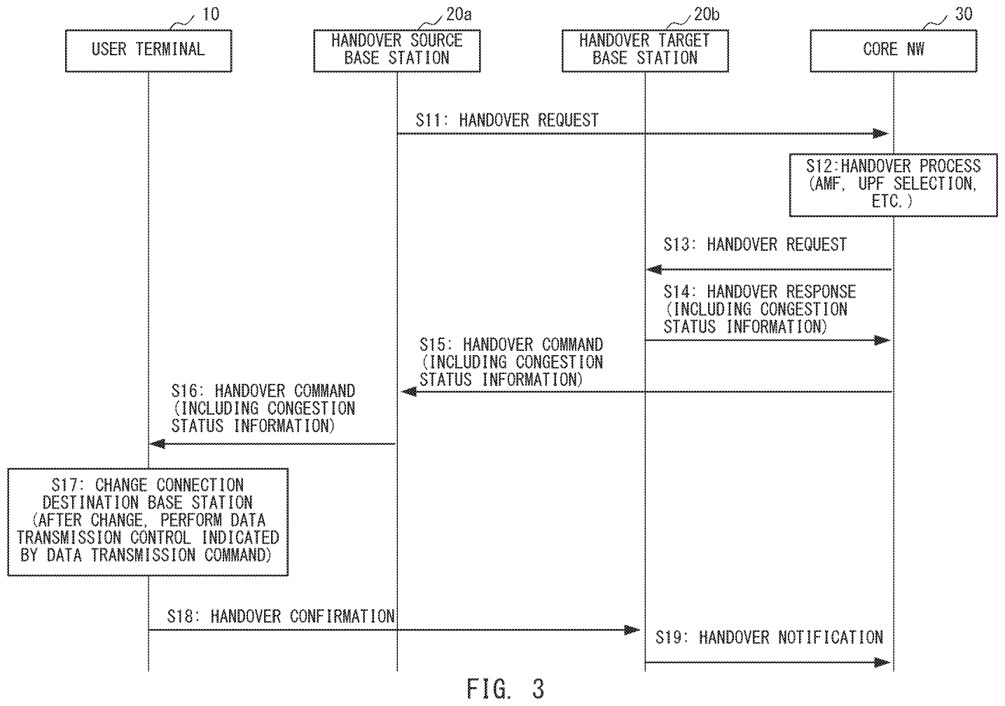

FIG. 3 is a diagram showing another example of the handover process. In this example, it is assumed that the user terminal 10 hands over from the base station 20a to the base station 20b. This example is a handover process when the handover source base station 20a and the handover target base station 20b are not connected via the Xn interface and cannot communicate directly.

The handover process illustrated in FIG. 3 is started when the handover source base station 20a determines that the user terminal 10 needs to be handover to the handover target base station 20b. Since the judgment of necessity of handover is the same as above, repeated explanations are omitted.

When the handover processing is started, in step S11, the baseband device 22a of the handover source base station 20a transmits a handover request (Handover Required) to the core network 30. This process can be regarded as transmission of a handover request from the handover source base station 20a to the handover target base station 20b via the core network 30.

In step S12, the core network 30 executes the handover processing in response to a handover request from the handover source base station 20a. The handover processing here includes, for example, selection of AMF and UPF.

In step S13, the core network 30 transmits a handover request to the handover target base station 20b.

In step S14, the handover target base station 20b transmits a handover response including congestion state information to the core network 30. Since the details of the congestion state information have been explained above, repeated explanations will be omitted.

In step S15, the core network 30 transmits a handover command including congestion state information to the handover source base station 20a.

In step S16, in response to receiving the handover command, the handover source base station generates a data transmission command according to the congestion state information, and transmits the handover command including the data transmission command to the user terminal 10.

In step S17, the user terminal 10 changes the connection destination base station from the base station 20a to the base station 20b in response to receiving a handover command from the handover source base station 20a. After the change of the connection destination, the user terminal 10 executes transmission control so as to perform transmission at the data rate or the data amounts included in the data transmission control command. Since this process is the same as the above, detailed explanation will be omitted.

In step S18, the user terminal 10 transmits a handover confirmation indicating that the handover is completed to the handover target base station 20b.

In step S19, the handover target base station 20b transmits a handover notification (Handover Notify) to the core network 30 in response to receiving the handover confirmation.

By the above processing, the handover processing of the user terminal 10 from the handover source base station 20a to the handover target base station 20b is completed.

### Advantageous Effect of the Present Embodiment

According to the present embodiment, when congestion occurs at the base station at the handover destination, the user terminal performs communication that suppresses the data rate or the amount of data after the handover, so that worsening of congestion can be suppressed. Conversely, when congestion occurs at the base station of the handover source and congestion does not occur at the base station of the handover destination, the user terminal can communicate with increased throughput after the handover, and the network utilization efficiency is improved. As described above, according to the present embodiment, it is possible to realize flattening of traffic and improving usage efficiency of the entire base station.

### <Other Variations>

The above embodiment is only an example, and the present disclosure can be appropriately changed and implemented within the range that does not deviate from the gist thereof.

Since the user terminal may transmit data at a data rate or data amount according to the state of the base station after handover, the process of obtaining the data rate or data amount after handover from the state information may be performed in any of the apparatuses of the handover source base station 20a, the handover destination base station 20b, and the user terminal 10.

Further, in the above, the connection between the handover source base station 20a, the handover destination base station 20b, and the core network 30 may have one or more other devices intervened therein.

The processes and means described in the present disclosure can be freely combined and implemented as long as there is no technical contradiction.

Further, the process described as being performed by one device may be shared and executed by a plurality of devices. Alternatively, the process described as being performed by different devices may be performed by one device. In the computer system, it is possible to flexibly change what kind of hardware configuration (server configuration) each function is realized.

The present disclosure is also feasible by supplying a computer program implementing the functions described in the above embodiment to a computer, and one or more processors included in the computer read out and execute the program. Such computer programs may be provided to the computer by a non-transitory computer-readable storage medium connectable to the computer's system bus, or may be provided to the computer over a network. A non-transitory computer-readable storage medium includes, for example, any type of disk, such as a magnetic disk (floppy disk, hard disk drive (HDD), etc.), an optical disk (CD-ROM, DVD disk, Blu-ray disk, etc.), a read-only memory (ROM), a random access memory (RAM), an EPROM, an EEPROM, a magnetic card, a flash memory, an optical card, and any type of medium suitable for storing electronic instructions.

What is claimed is:

1. A communication system comprising: a first base station having a first controller and a second base station having a second controller, wherein
the first controller transmits a handover request to the second base station when a handover to the second base station is required for a user terminal,
the second controller transmits a handover response including congestion state information at the second base station to the first base station in response to receiving the handover request, and
the first controller transmits a handover command including the congestion state information or a data transmission control command according to the congestion state information to the user terminal in response to receiving the handover response.

2. The communication system according to claim 1, wherein the second controller acquires the congestion state information based on at least one of a usage rate of an arithmetic processor, a usage rate of a memory, a usage rate of the communication bandwidth, and a usage rate of wireless resource.

3. The communication system according to claim 1, wherein the user terminal performs control of data transmission based on the congestion state information or the data transmission control command after handover to the second base station.

4. The communication system according to claim 3, wherein the user terminal performs control of data transmission according to the priority of communication data when suppressing the amount of data transmission after handover to the second base station.

5. A method of communication comprising:
transmitting, by a first base station, a handover request to a second base station when the first base station determines that a handover of a user terminal to a second base station is necessary;
transmitting, by the second base station, a handover response including congestion state information at the second base station to the first base station in response to receiving the handover request; and
transmitting, by the first base station, a handover command including a data transmission control command according to the state information or the state information to the user terminal in response to receiving the handover response.
